(19) United States
(12) Patent Application Publication
(10) Pub. No.: US 2014/0044364 A1
(43) Pub. Date: Feb. 13, 2014

(54) Method of Image Identification Based on Artificial Intelligence

(71) Applicants: Melih Abdulhayoglu, Montclair, NJ (US); Shane McGillian, New York, NY (US)

(72) Inventors: Melih Abdulhayoglu, Montclair, NJ (US); Shane McGillian, New York, NY (US)

(21) Appl. No.: 13/093,259

(22) Filed: Apr. 25, 2011

Related U.S. Application Data
(60) Provisional application No. 61/327,303, filed on Apr. 23, 2010.

(51) Int. Cl. G06K 9/62

(52) U.S. Cl. CPC G06K 9/6201
USPC 382/219

(57) ABSTRACT

A method of image identification based on artificial intelligence is provided, the method includes initializing a second computer with a first computer supplying and accepting image data from the first computer to the second computer; comparing the delivered image data in the second computer to pre-existing stored images in the second computer; generating and displaying a first result if the delivered image data is the same as the stored image in the second computer and a second result if the delivered image data is not the same as the stored image data; and un initializing the second computer based on the first and second results.

### CLAIM OF PRIORITY

This Application claims priority from Provisional Application 61/327,303 filed on Apr. 23, 2010, the teaching of which is incorporated fully herein by reference.

### BACKGROUND OF THE INVENTION

The present invention relates generally to a computer hardware and software security method and, in particular, to a method of image identification using artificial intelligence. With the growing size and use of the Internet the ability to confirm the identity of a company becomes vitally important for the end users. Commercial enterprises and organizations use logos as symbols associated with their goods or services and thus provide public recognition. Logos can be either purely graphic (symbols/icons) or are composed of the name of the organization (a Logotype or word mark.)

Recognizable logo on a company's webpage can add certain trust to this entity, but cannot fully guarantee its identity. A logo on a webpage that user is viewing may differ in dimensions (size, color, aspect ratio, file format, quality, typeface) from the original logo, however, it would be easily recognizable by a human viewer as logo of the same well known company or Trademark. The reasons for differences in dimensions could be due to processing of original image before displaying it on the webpage viewed by an end user or forgery of original image by this webpage. Of course, by simply performing a check match or hash-value match one could easily determine if original image and image from the webpage are the same. However, for human viewers differences in dimensions may be not noticeable and they would consider the logo as the same. Especially in situations when a human is viewing a logo in isolation on a webpage and isn't actively trying to compare two images.

There have are currently developed methods for logo recognition based on syntactic approach and statistical model. Also a connectionist-based approach dealing with spot noises has been proposed. Though this approach is rather effective it has difficulties when applied to strong symbol's component. More successful method here would combine symbolic and sub-symbolic processing, instead of only operating with real values.

Therefore, there is a need in method and system that would be able to provide thorough investigation and accurate identification of corporate logos in web pages thus confirming to user that they are visiting the intended website.

### SUMMARY OF THE INVENTION

The current invention is an artificial intelligence based method and system for recognizing corporate logos in web pages, IMAGE_A, by comparing the webpage contents against a typical example of known corporate logo, IMAGE_B.

This method is able to recognize any differences and distinctions between IMAGE_A and IMAGE_B such that while a human would consider them as the same logo even though the logos have some differences. Thus method described in invention handles such differences so that IMAGE A on a webpage viewed by user is recognized and identified as IMAGE_B in the source images.

### BRIEF DESCRIPTION OF THE DRAWINGS

The above and other objects, features and advantages of the present invention will become more apparent from the following detailed Description when taken in conjunction with the accompanying drawings in which:

FIG. 1 is a flowchart of an image identification process according to the present invention;

FIG. 2 is a schematic diagram of image identification according to the present invention;

FIG. 3 is a depiction of a company provider's system utilizing a client server according to the present invention; and

FIG. 4 is a depiction of a company provider's system utilizing a crawler server according to the present invention.

### DETAILED DESCRIPTION OF THE PREFERRED EMBODIMENTS

Preferred embodiments of the present invention will be described herein below with reference to the accompanying drawings. In the Following description, well-known functions or constructions are not described in detail since they would obscure the invention in unnecessary detail.

The present invention discloses an artificial intelligence based method and system of authenticating corporate logo by comparing it to corporate logos database located in company provider's system.

The invention is not limited to the details of the foregoing embodiments. The invention may extend to any novel one, or any novel combination, of the features disclosed in this specification (including any accompanying claims, abstract and drawings), or to any novel one, or any novel combination, of the steps of any method or process so disclosed.

Here company provider's software is a system which provides the interface to the client software subsystem to process the requests from client software subsystem and return results to the client software. Company provider holds the database of original logos used for comparison with ₜhose found on the web. The client software subsystem is a system which creates an image from a webpage, supplies data to company provider's software and gets results back and informs user about them.

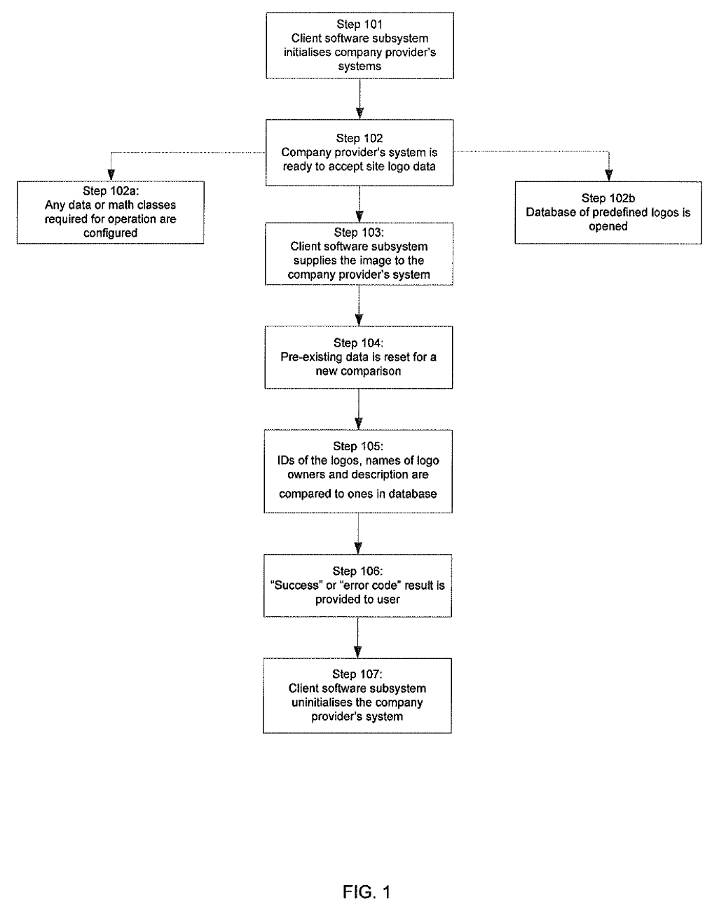

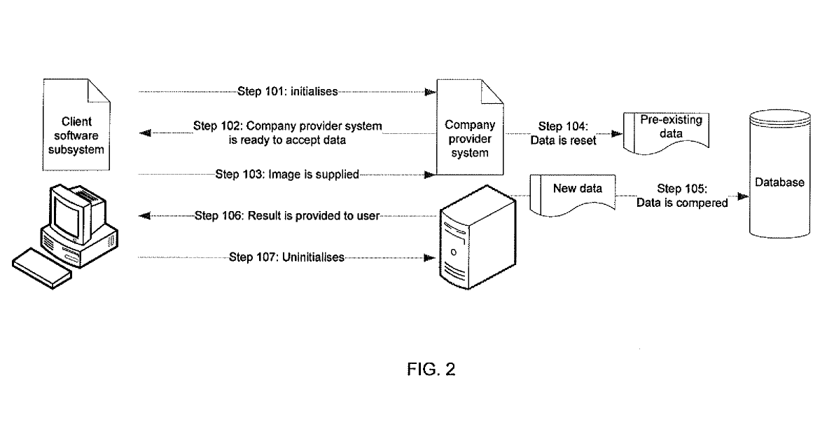

In FIGS. 1 and 2, when the system is setup and logo database are configured. In Step 101 the client software subsystem will initialize company provider's systems. The initialize function is the trigger to create and configure company provider's system ready to accept site logo data. Here parameter of memory usage determines how aggressive the sub-systems should be on computer RAM usage where “1” is low memory usage and “100” is full aggressive usage. Generally in a client environment the figures would be set to a lower number, e.g. 50, and for a server environment at maximum level of 100. Actions timed out at this time include such items as opening the database of predefined logos and configuring any data or math classes required for operation.

In Step 102, the Company provider's system is now ready to accept site logo data. Furthermore,

Step 102 includes configuring any data or math classes required for operation Step 102a and the database of predefined logos is opened 102b.

In Step 103, the client software subsystem supplies the image to the company provider's system and sets the web page to be analyzed. Client software Subsystem creates an image from a webpage and its position coordinate boundaries of the logo in the page are “x” and ‘y”, (width and height corresponding) are sent back to the company provider's system. Thus in Step 104 this call resets any pre-existing data and a new comparison is assumed to be carried out. In Step 105 the comparison is made on the supplied web page parameters: IDs of the logos, names of logo owners and description are compared to ones in database. It should be assumed that the image for detection could be located in part in pbImage (image on a web page) or that pbImage alone (pbImage is the entire image to match) could be the entire logo for matching. Such parameters as type of image and size of image are to be determined. The match ratio for the comparison based on the is the real number between 0 and 1, where “1” means exact match, “0” theoretically mean no match. Based on the comparison outcome, a result is displayed to the end user. the end user in step 106, which may be “success” or “error code”

In Step 107 the client software subsystem will un-initialized the company provider's system and configure the database into a closed state.

Therefore, but comparing the image data to a known “control” image, the parameters can be analyzed to ensure that the sample image is genuine. An end user may therefore be made aware if the logo is or is not genuine. The user can then further be assured that the website is the actual website of the company in question as only the actual company would be able to verify the parameters of the “control” image data.

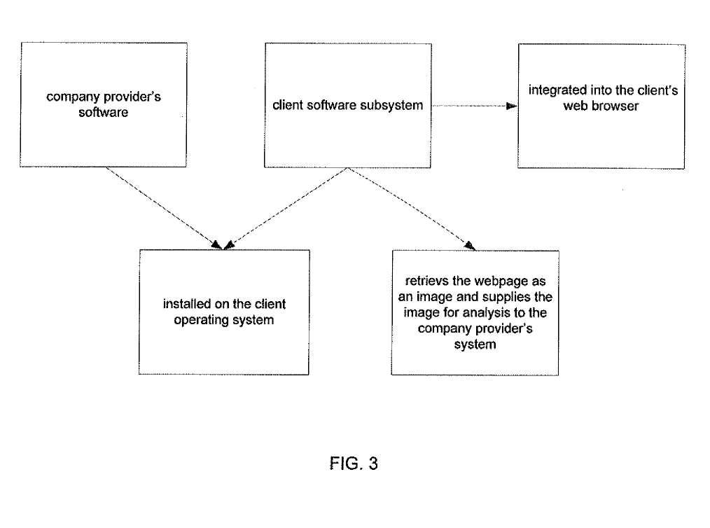

The company provider's system will potentially be run in two operational scenarios which are detailed as follows: running on a client and running of a crawler server. As depicted in FIG. 3, when running on a client, the company provider's software and client software subsystem will both be installed on the client operating system with client software subsystem integrated into the clients web browser. The target operating system for this scenario may generally be, but not limited to, a Microsoft Windows operating system. The client software subsystem will be responsible for retrieving the webpage as an image and supplying the image for analysis to the company provider's system.

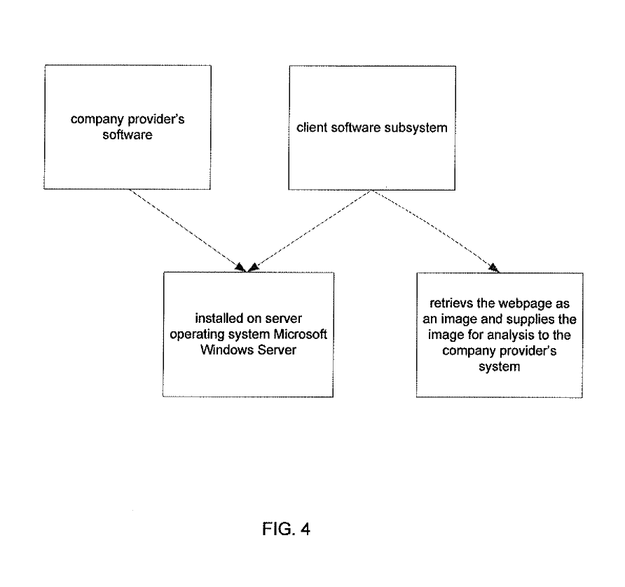

As shown in FIG. 4, when running on a crawler server, the company provider's software and the client software subsystem will both be installed on a server operating system Microsoft Windows Server. The client software subsystem will be responsible for retrieving the webpage as an image and supplying the image for analysis to the company provider's software. Target operating systems may be the following for example: Microsoft Windows: XP, XP-Professional, Microsoft Vista all versions; Microsoft Windows 7 all versions.

The choice of database used by company provider's software should be database independent preferably no specific custom database access (such as MS ADO) should be used. This is to enable the ability to move to a different database if required for operational reasons.

Due to the operational scenarios, the company provider's software in accordance with the present invention may be run on a client PC that has limited resources wherein the CPU and memory of the target system in indeterminate, therefore, a base system should be accessible by the majority of current users. In the server environment the system specification can meet and exceed the needs of the company provider's software system by installing a scalable system.

What is claimed is:

1. A method of image identification, comprising:
Initializing a second computer with a first computer;
Supplying a set of sample image data from said first computer to said second computer;
Comparing said set of sample image data in said second computer to pre-existing stored image data for a control image in said second computer;
generating and displaying a first result if said sample image data is the same as said stored image data for said control image in said second computer and a second result if said sample image data is not the same as said stored image data for said control image in said second computer; and,
un-initializing the second computer based on the first and second results.

2. A method of image identification, wherein said sample image data includes image size parameters.

3. A method of image identification, wherein said sample image data includes image pixel parameters.

4. A method of image identification, wherein said sample image data includes a hash of image data parameters.
